(19) United States
(12) Patent Application Publication
(10) Pub. No.: US 2025/0138564 A1
(43) Pub. Date: May 1, 2025

(54) PRIORITIZATION OF CONCURRENT REGULATION LOOPS IN A VOLTAGE REGULATOR

(71) Applicant: NXP B.V., Eindhoven (NL)

(72) Inventors: Vincent Geffroy, Cuverville (FR); Jean-Robert Tourret, Cormelles Le Royal (FR); Franck Goussin, Blainville sur Orne (FR); Frederic Darthenay, Luc Sur Mer (FR)

(21) Appl. No.: 18/914,694

(22) Filed: Oct. 14, 2024

(30) Foreign Application Priority Data
Oct. 25, 2023 (EP) 23306864.2

(51) Int. Cl. G05F 1/575; G05F 1/563; G05F 1/59

(52) U.S. Cl. CPC G05F 1/575; G05F 1/563; G05F 1/59

(57) ABSTRACT

A voltage regulator utilizes an external pass transistor coupled between a supply voltage node and a regulated node. The voltage regulator includes an internal pass transistor that is coupled between the supply voltage node and the regulated node. A two-tap voltage divider between the regulated node and a ground node provides two feedback voltages. A first control loop that controls the external pass transistor receives the first feedback voltage and a second control loop that controls the internal pass transistor receives the second feedback voltage. At startup the control loops run concurrently but the first control loop is prioritized to reduce load current provided by the internal pass transistor at the end of startup. The voltage difference between the first and second feedback voltages ensures prioritization of the first control loop and the external pass transistor supplies most or all of the load current.

### BACKGROUND OF THE INVENTION

### Field of the Invention

This invention relates to voltage regulation, and more particularly to regulation of low dropout regulators using concurrent control loops.

### Description of the Related Art

A low dropout (LDO) voltage regulator provides a constant voltage to a load even as the load changes. For high current loads, e.g., in automobile applications, an external pass device can be used to supply current to the load from a power source such as a battery. In many implementations, it can be advantageous for the voltage regulator to also include an internal pass device and use either the external pass device or the internal pass device to supply the load current. The high heat dissipation associated with the external pass device supplying a high load current prevents integration of the external pass device into the integrated circuit that contains the remainder of the voltage regulator. Advantageously, use of the external pass device places most of the power dissipation associated with the external pass device outside of the integrated circuit to help meet thermal limitations of the integrated circuit. However, the presence of the external pass device is unknown at startup.

### SUMMARY OF EMBODIMENTS OF THE INVENTION

Accordingly, to address the uncertainty as to whether an external pass device is present for use by the voltage regulator, in an embodiment a voltage regulator includes a first control loop to generate a first control signal for a first pass transistor, the first control signal coupled to an output terminal of an integrated circuit. A second pass transistor that is internal to the integrated circuit is coupled between a supply voltage node and a regulated voltage node. A second control loop to generate a second signal for the second pass transistor. A voltage divider circuit is coupled between the regulated voltage node and a ground node and provides a first feedback voltage from a first tap of the voltage divider circuit to the first control loop and provides a second feedback voltage from a second tap of the voltage divider circuit to the second control loop.

In an embodiment the voltage regulator further includes the first pass transistor external to the integrated circuit and the first pass transistor is coupled to the first control signal through the output terminal of the integrated circuit and the first pass transistor is coupled between the supply voltage node and the regulated voltage node.

In an embodiment of the voltage regulator, the first control loop has higher priority than the second control loop to thereby reduce an amount of current supplied by the second pass transistor.

In an embodiment of the voltage regulator, the first control loop includes a first error amplifier having a first input coupled to the first feedback voltage and a second input coupled to a reference voltage and the first error amplifier supplies the first control signal.

In an embodiment of the voltage regulator, the second control loop includes a second error amplifier having a first input coupled to the second feedback voltage and having a second input coupled to the reference voltage and the second error amplifier generates the second control signal that is coupled to a control terminal of the second pass transistor.

In an embodiment of the voltage regulator, during a startup sequence, by default the first control loop and the second control loop run concurrently and the first control loop is prioritized to ensure that the first pass transistor provides more current than the second pass transistor at the end of the startup sequence and after the startup sequence completes the first control loop can be disabled and the second control loop can be disabled.

An embodiment of the voltage regulator includes a first switch and a second switch to cause the first error amplifier to receive the first feedback voltage responsive to assertion of both an external ballast enable signal and an internal ballast enable signal and to receive the second feedback voltage responsive to the second control signal being deasserted.

In an embodiment of the voltage regulator, the first error amplifier is responsive to a first value of an external ballast enable signal to turn on and to a second value of the external ballast enable signal to turn off to thereby disable the first pass transistor and the second error amplifier is responsive to a first value of an internal ballast enable signal to turn on and to a second value of the internal ballast enable signal to turn off and thereby disable the second pass transistor.

In an embodiment, the voltage regulator includes a plurality of switches configured to select the first feedback voltage for the first control loop during startup and to select the second feedback voltage for the first control loop responsive to the second control loop being disabled after startup.

In another embodiment a method for generating a regulated voltage includes controlling a first pass transistor that is external to an integrated circuit using a first control loop. The method further includes controlling a second pass transistor that is internal to the integrated circuit using a second control loop that runs concurrently with the first control loop. The method further includes supplying a first feedback voltage from a first tap of a voltage divider circuit to the first control loop and supplying a second feedback voltage from a second tap of the voltage divider circuit to the second control loop.

In an embodiment the method further includes prioritizing use of the first pass transistor based on a voltage difference between the first feedback voltage and the second feedback voltage.

In an embodiment the method further includes supplying the first feedback voltage to a first input of a first error amplifier in the first control loop, supplying a reference voltage to a second input of the first error amplifier, and supplying an error output signal of the first error amplifier to a control terminal of the first pass transistor to control the first pass transistor.

In an embodiment the method further includes causing the first error amplifier to receive the second feedback voltage after a startup sequence.

In an embodiment the method further includes turning on the first error amplifier responsive to a first value of an external ballast enable signal and turning off the first error amplifier responsive to a second value of the external ballast enable signal to thereby disable the first pass transistor.

In an embodiment the method further includes supplying the second feedback voltage to a first input of a second error amplifier in the second control loop, supplying a reference voltage to a second input of the second error amplifier, and supplying an error output signal of the second error amplifier to a control terminal of the second pass transistor to control the second pass transistor.

In an embodiment the method further includes prioritizing the first control loop by default during a startup sequence.

In an embodiment the method further includes disabling the first control loop or the second control loop after the startup sequence completes.

In an embodiment the method further includes turning on the second error amplifier responsive to a first value of an internal ballast enable signal and turning off the second error amplifier responsive to a second value of the internal ballast enable signal to thereby disable the second pass transistor.

In another embodiment a voltage regulator includes an internal pass transistor that is internal to the integrated circuit and is coupled between a supply voltage node and a regulated voltage node. A voltage divider circuit is coupled between the regulated voltage node and a ground node and provides a first feedback voltage from a first tap of the voltage divider circuit and provides a second feedback voltage from a second tap on the voltage divider circuit. A first control loop supplies a first control signal to an output terminal of the integrated circuit, the first control signal for controlling an external pass transistor. The first control loop includes a first error amplifier that receives the first feedback voltage and a reference voltage and supplies a first error amplifier output signal to control the external pass transistor when present. A second control loop supplies a second control signal to a control terminal of the internal pass transistor. The second control loop includes a second error amplifier that receives the second feedback voltage and the reference voltage and supplies a second error amplifier output signal as the second control signal. A voltage difference between the first feedback voltage and the second feedback voltage prioritizes the first control loop.

The voltage regulator further includes the external pass transistor, which is external to the integrated circuit. The external pass transistor is coupled to the first control signal through the output terminal of the integrated circuit and the external pass transistor is coupled between the supply voltage node and the regulated voltage node.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 illustrates an embodiment of a power management circuit (PMC) having a stacked voltage regulator arrangement.

FIG. 2 illustrates a high-level block diagram of an embodiment of a low drop out regulator with an internal ballast and an external ballast.

FIG. 3 illustrates a high-level block diagram of an embodiment of a voltage regulator with an internal ballast and an external ballast and two regulation loops, one of which is prioritized.

FIG. 4A illustrates generation of the regulated voltage during startup in an embodiment.

FIG. 4B shows a timing diagram of the currents through the pass transistors during the startup sequence in an embodiment in which the feedback voltages in the control loops are equal.

FIG. 4C illustrates an embodiment where the preference is given to the external control loop over the internal control loop by ensuring there is a sufficient voltage difference between the feedback voltages.

FIG. 5 illustrates additional implementation details of an embodiment of an LDO regulator giving preference to the external control loop.

FIG. 6 illustrates the user programming use of the internal or external ballast after the startup period ends.

FIG. 7 illustrates an embodiment in which a higher output voltage is provided during startup while using two control loops with the dual tap voltage divider and a lower output voltage is provided with only a single control loop being used after user programming after startup is complete.

The use of the same reference symbols in different drawings indicates similar or identical items.

### DETAILED DESCRIPTION

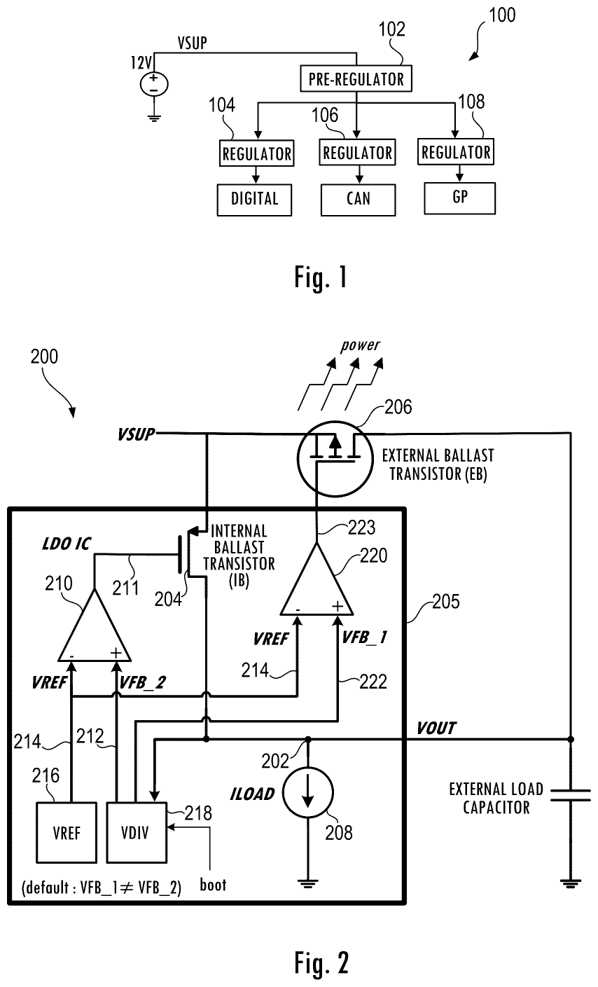

FIG. 1 illustrates an embodiment of a power management circuit (PMC) 100 in an automotive application having a stacked voltage regulator arrangement in which a pre-regulator 102 receives 12V from the battery supply (VSUP) and supplies a regulated 6V to additional regulators 104, 106, and 108. The regulators 104, 106, and 108 supply a lower regulated voltage, e.g., 3.5/5V, to different voltage domains. For example, regulator 104 supplies voltage to a digital logic voltage domain. Regulator 106 supplies voltage to a controller area network (CAN) voltage domain and regulator 108 supplies voltage to a general purpose (GP) voltage domain. Embodiments described herein ensure the safe activation of the automotive 12-V battery voltage (VSUP) pre-regulation system.

FIG. 2 illustrates an embodiment of a low drop out (LDO) regulator 200 that can be used as the pre-regulator 102. The LDO 200 provides a regulated voltage VOUT (e.g., 6V) at node 202. The LDO pre-regulator includes both an internal pass transistor (ballast) 204 that is internal to integrated circuit 205 and an external pass transistor (ballast) 206 that is external to integrated circuit 205. The integrated circuit 205 includes control circuits for both the internal pass transistor 204 and the external pass transistor 206. Note that the terms “pass transistor” and “ballast” are used interchangeably herein. The external pass transistor 206 can support a much higher current load than the internal pass transistor 204. Both the internal and external pass transistors control the amount of current supplied to the load and regulate the voltage according to their gate voltages.

In an embodiment for an automobile application, in a full-power mode (FPM) the LDO regulator 200 supplies a high load current 208, e.g., for a brushless DC motor, from the external pass transistor 206. In full-power mode, the use of the external pass transistor 206 allows the LDO regulator 200 to dissipate heat associated with the external pass transistor 206 outside the integrated circuit package. If the external pass transistor was not used, for certain applications the heat dissipation would be too high for the integrated circuit 205 and lead to an unacceptable risk of damage.

The LDO regulator 200 includes an error amplifier 210 used to control the internal pass transistor 204. The error amplifier 210 compares a feedback voltage 212 (VFB2) from the voltage divider circuit 218 to a reference voltage (VREF) 214 supplied from a reference voltage generator 216 and supplies its output signal 211 to the gate of internal pass transistor 204. The LDO regulator 200 further includes the error amplifier 220 that receives the feedback voltage (VFB1) 222 from the voltage divider circuit 218. The error amplifier 220 also receives the reference voltage VREF 214. The output 223 of error amplifier 220 is supplied to the gate terminal of the external pass transistor 206 to control the current through the pass transistor 206 and regulate the output voltage. At boot, i.e., when the LDO starts up, the presence of the external ballast is unknown. In embodiments described herein the LDO regulator has a default state at startup that allows for the presence or absence of the external ballast without harm coming to LDO regulator and particularly to the integrated circuit 205. In an embodiment the default state for the LDO regulator 200 utilizes two coexisting regulation loops (also referred to herein as control loops), one internal regulation loop to control the internal pass transistor 204 and an external regulation loop to control the external pass transistor 206. The two regulation loops control a single output. Note that the integrated circuit 205 contains both the internal regulation loop and the external regulation loop with the gate signal for the external ballast transistor 206 being supplied off-chip from the external regulation loop.

To address the problem of not knowing whether the external ballast is present at startup, embodiments activate the two regulation loops using default state programming. At startup the pre-regulator gives priority to the external ballast regulation loop and the high-current capability of the external ballast, hence protecting the integrity of the internal ballast and other circuitry of the integrated single-voltage output LDO regulator. That approach helps ensure thermal dissipation in the integrated circuit is maintained at acceptable levels. That approach is useful in cases in which both an internal and an external ballast are present and if the external setup is unknown. While the external regulation loop takes priority to cause the external ballast to conduct all the payload current eventually, the internal regulation loop remains active but does not contribute significantly to the payload current by the end of the start-up sequence. Once the start-up sequence is complete, the user can program one of three scenarios: the user keeps the default concurrent mode with both the external and internal regulation loops running or else the user selects the desired regulation mode, namely either internal or external, which results in one of the regulation loops being shut down.

In an embodiment an external ballast (EB) enable bit, which supplies an EB enable signal for external ballast mode, activates the external regulation loop when asserted (EB=1) and the internal ballast (IB) enable bit, which supplies an IB enable signal for internal ballast mode, activates the internal regulation loop when asserted (IB=1). While it is possible to have a default state in which the EB enable bit is asserted and the IB enable bit is deasserted, that assumes the external ballast transistor is present, which is unknown. Alternatively, one could start with the IB enable bit asserted to enable the internal regulation loop and the EB enable bit deasserted, but the expected high current demand could cause unacceptable internal thermal stress on the integrated circuit. The high current demand particularly stresses the internal pass transistor, which occupies a highly constrained surface. Thus, embodiments include a current limiter circuit (which are well known in the art) to protect the internal pass transistor from irreversible damage. Instead of defaulting to IB=1 and EB=0 or EB=1 and IB=0, embodiments at startup default to IB=1 and EB=1. Thus, both regulation loops are active and run concurrently, which allows for a safe start with both the internal regulation loop and the external regulation loop with higher priority being given to the external regulation loop. That helps assure that heat dissipation occurs outside the LDO integrated circuit while still supplying the desired load current. If the external ballast is not present, satisfactory regulation is still ensured using the internal regulation loop although the current limiter may limit the load current supplied by the internal ballast to a less than desired level. However, in applications where the load current demand is sufficiently low, the LDO regulator can be used without the external ballast and utilizing only the internal ballast to provide the desired load current.

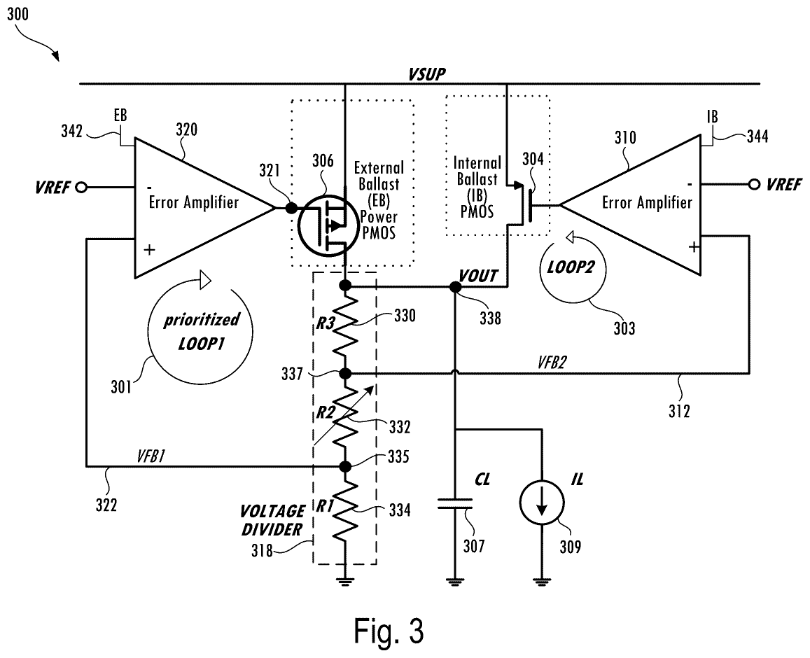

FIG. 3 illustrates a high-level block diagram of an embodiment of an LDO voltage regulator 300 with internal and external regulation loops that run concurrently. The LDO regulator 300 includes the prioritized main control loop (LOOP1) 301 to regulate the external pass device 306 and the auxiliary control loop 303 (LOOP2) for the internal pass device 304. The load is represented by the load capacitance (CL) 307 and the load current (IL) 309. LOOP2 further includes the error amplifier 310 and LOOP1 further includes the error amplifier 320. The voltage divider circuit 318 generates the voltage feedback signals VFB2 312 and VFB1 322, which are divided down voltages from the regulated output voltage VOUT present at node 338. The feedback signals supply the divided down feedback voltages to the error amplifiers 310 and 320. The voltage divider circuit 318 uses a dual-tap arrangement that includes serially coupled resistors R3 330, R2 332, and R1 334. The feedback voltage VFB1 comes from node 335 between R1 and R2 and the feedback voltage VFB2 comes from node 337 between R3 and R2. VFB1 is a lower voltage than VFB2. The error amplifiers 310 and 320 also receive the reference voltage VREF, which in embodiments is provided from a bandgap or other appropriate voltage reference circuit. Note that the resistor R2 is programmable in the illustrated embodiment. That allows the feedback voltages VFB1 and VFB2 to be tuned to desired voltage levels. Of course, other embodiments may use a fixed resistor for R2.

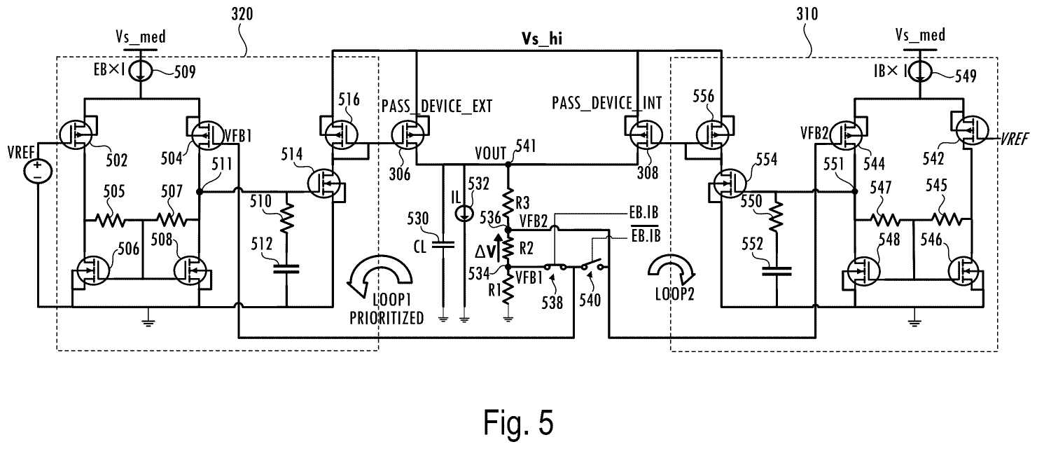

The control loop LOOP1 (the external regulation loop) is prioritized by supplying a lower feedback voltage VFB1 to error amplifier 320 than the feedback voltage VFB2 utilized in LOOP2 (the internal regulation loop). That ensures that LOOP1 keeps the regulated voltage at appropriate levels and the desired load current flowing through the external pass transistor 306. Error amplifier 320 supplies the gate signal to external pass transistor 306 through the output terminal 321. The feedback voltage VFB2 at node 337 increases as VREF reaches the desired VREF value at the end of the startup sequence, which causes the error amplifier 310 to generate an output signal that turns off internal pass transistor 304 (or at least significantly reduces the current through the transistor) to stop or significantly reduce the load current provided through the internal pass transistor 304. Note that having VFB1<VFB2 to ensure prioritization of LOOP1, holds true for embodiments with error amplifiers using PMOS differential transistor pairs as shown, e.g., in FIG. 5. For an embodiment in which the error amplifiers use NMOS differential transistor pairs, the feedback voltages are chosen so VFB1>VFB2.

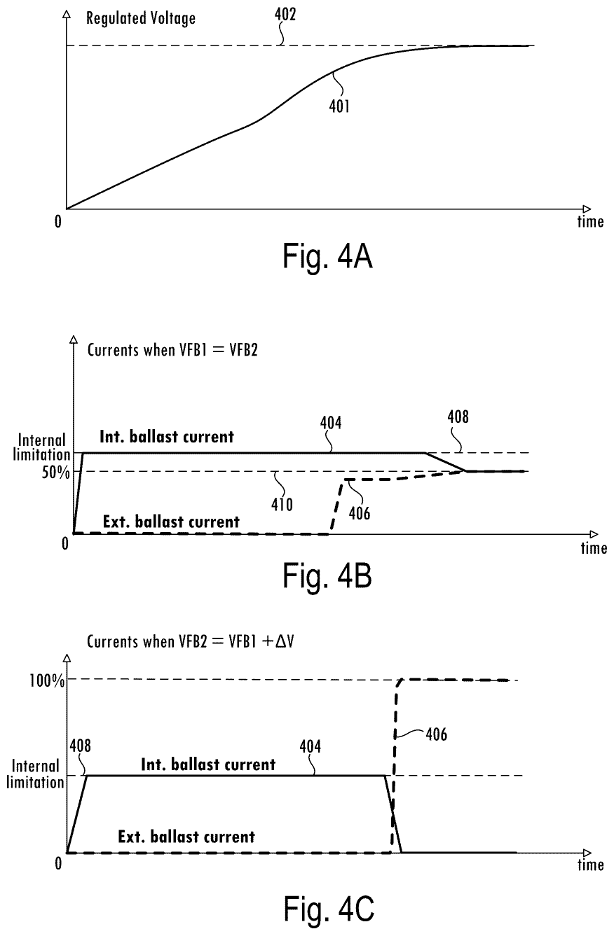

FIGS. 4A, 4B, and 4C illustrates graphically how prioritizing the control loop LOOP1 allows for a safe startup sequence. FIG. 4A shows that the regulated voltage 401 rises during startup to the desired level 402, which is the level to be achieved in both FIGS. 4B and 4C. FIG. 4B shows a timing diagram of the currents through the pass transistors during the startup sequence in which the feedback voltages VFB1 and VFB2 are equal. That is, assume a single tap voltage divider provides the same feedback voltages to both LOOP1 and LOOP2. The current 404 flowing through the internal pass transistor starts more quickly than the current 406 flowing through the external pass device due to the larger device size of the external pass transistor causing the larger device to start more slowly. Assuming the two control loops include error amplifiers with the same technology, same class of transistors, and similar biasing currents, the correlation between the two control loops is very high and the probability that the current is equally shared between the internal and external pass transistors is also high. As shown in FIG. 4B, the internal current 404 starts more quickly and reaches an internal current limit 408. An internal current limiter limits the internal ballast current to a desired level shown as the current limit 408. As the external pass transistor starts up, the two control loops approach a shared current of 50% at 410. While a 50% current limit can be tolerated for a short period of time, the 50% current contribution from the internal pass transistor cannot be sustained long term without excessive heat dissipation potentially damaging the integrated circuit in which the internal ballast resides. Thus, to achieve a satisfactory startup sequence with two control loops running, preference should be given to the control loop (LOOP1) that controls the external pass transistor to reduce the current contribution from the internal pass transistor to an acceptable level. In an embodiment, the current contribution from the internal pass transistor is reduced to substantially zero.

FIG. 4C illustrates an embodiment where the preference is given to the external control loop by ensuring there is a sufficient difference between the feedback voltages VFB1 and VFB2. As explained with relation to FIG. 3, VFB1<VFB2. That voltage difference overcomes the strong correlation that exists in the two control loops due to the use of error amplifiers of the same class and thus similar in current-voltage characteristics. In an embodiment, the voltage difference is approximately 100 mV. Of course, that voltage difference can differ according to the needs of the particular system. FIG. 4C shows the internal pass transistor current 404 starts first and rises to the internal current limit 408. The external pass transistor current 406 starts more slowly but eventually rises to supply approximately 100% of the load current by the end of the startup sequence. As the external pass transistor current ramps up, the internal pass transistor current 404 ramps down to substantially zero. While the external pass transistor supplies 100% of load current in the example shown in FIG. 4C, in other embodiments the target load current supplied by the external pass transistor may be less, e.g., 90%, as long as the load current supplied by the internal pass transistor can be safely sustained long term by the LDO regulator IC.

FIG. 5 illustrates some additional implementation details of an embodiment of an LDO regulator in which the control loop (LOOP1) controlling the external pass transistor has priority at startup by default. The major components of the LDO regulator of FIG. 5 have the same reference numerals as the LDO regulator shown in FIG. 3. LOOP1 contains three stages with two stages located inside the error amplifier 320. The pass transistor 306 forms the third stage. The first stage of LOOP1 includes the PMOS differential transistor pair 502 and 504 operating in moderate inversion around the threshold voltage of the PMOS devices. The first stage further includes NMOS transistors 506 and 508 and resistors 505 and 507. The first stage receives a current from current source 509 when the external ballast (EB) enable signal is asserted. The PMOS transistor 502 operates with a fixed gate voltage (VREF) while PMOS transistor 504 operates with a varying gate voltage VFB1. VFB1 varies according to the output voltage VREF to maintain the output voltage at the desired level. The lower the voltage of VFB1, the stronger transistor 504 turns on and the higher VFB1 is, the higher the resistance of PMOS transistor 504 and less current flows. Transistors 506 and 508 provide an active load for the first stage with common mode feedback through resistors 505 and 507.

The first stage of the error amplifier at node 511 couples to the second stage with a voltage corresponding to the difference between VREF and VFB1. The second stage of error amplifier 320 includes NMOS transistor 514 and PMOS transistor 516. The serially coupled resistor 510 and capacitor 512 form the interstage compensation network to stabilize the control loop (LOOP1). The node 511 is the input to the second stage of the error amplifier 320, i.e., to the gate terminal of the NMOS transistor 514. The current through PMOS transistor 516 depends on the magnitude of the error signal (difference between VREF and VFB1 multiplied by a gain factor) supplied from the first stage at node 511. PMOS transistor 516 forms a current mirror with the pass device 306. Thus, the current through transistor 516 is multiplied according to the size ratios of transistors 306 and 516. The load on the LDO regulator is shown as the capacitive load (CL) 530 and the load current (IL) 532. The voltage divider includes resistors R3, R2, and R1 with VFB1 (at startup) coming from node 534 between R2 and R1 and VFB2 coming from the node 536 between resistors R3 and R2. Switches 538 and 540 are controlled by the external ballast (EB) enable signal and the internal ballast (IB) enable signal. Those signals are ANDed together to control the switch 538 and the complement of those signals ANDed together controls the switch 540. When both EB and IB are asserted, switch 538 is closed and 540 is open. That ensures that at startup, there is a difference between VFB1 and VFB2 and LOOP1 is prioritized by VFB1 being lower than VFB2. When either of the enable signals is deasserted (set to 0 in this embodiment), switch 538 is open and 540 is closed, which will be discussed further herein.

The control loop LOOP2 also contains three stages with two stages located inside the error amplifier 310 and the pass transistor 308 forming the third stage. The components in error amplifier 310 and 320 are of the same class and so have similar in current-voltage characteristics. For the control loop LOOP2 the first stage includes the PMOS differential transistor pair 542 and 544 operating in moderate inversion around the threshold voltage of the PMOS devices. The first stage further includes NMOS devices 546 and 548 and resistors 545 and 547. The first stage receives a current from current source 549 when the internal ballast (IB) enable signal is asserted. Transistor 542 receives the steady state reference voltage VREF and transistor 544 receives the feedback voltage VFB2, which varies according to VOUT. The higher VFB2 is, the less PMOS transistor 544 turns on. Transistors 546 and 548 provide an active load for the first stage with common mode feedback through resistors 545 and 547.

The first stage of the error amplifier couples to the second stage with a voltage at node 551 corresponding to the difference between VREF and VFB2. The second stage of error amplifier 310 includes NMOS transistor 554 and PMOS transistor 556. The serially coupled resistor 550 and capacitor 552 form the interstage compensation network to stabilize the control loop (LOOP2). The node 551 is the input to the second stage of the error amplifier 310, i.e., to the gate terminal of the NMOS transistor 554. The current through PMOS transistor 556 depends on the voltage error signal from the first stage present on node 551. PMOS transistor 556 forms a current mirror with the pass transistor 308. Thus, the current through transistor 556 is multiplied according to the size ratios of transistors 308 and 556.

At startup the external ballast (EB) enable signal and the internal ballast (IB) enable signal are both asserted by default causing the two current sources supplying the error amplifiers to be enabled and causing switch 538 to be closed and switch 540 to be open. That ensures a voltage difference between VFB1 and VFB2 at startup, which results in LOOP1 being prioritized. While FIG. 5 illustrates an embodiment of an error amplifier with a PMOS differential pair, one of skill understands that many error amplifier implementations are possible, e.g., using NMOS differential pairs, and the particular implementation of the error amplifier used with the double tap resistor divider can vary in different embodiments.

The characteristic of the moderate-inversion differential pair versus the input error is exploited knowing it is related to the product of the thermal voltage VT=kT/q (25.69 mV at 25° C.) and a bias dependent factor named n, where n is slightly higher than 1, e.g., assume 1.3. The prioritization of LOOP1 is ensured by ensuring a sufficient voltage difference between the feedback voltages VFB1 and VFB2. As VFB2 rises, the differential pair in LOOP2 reflects that change and the first stage acts as an open switch inside LOOP2 causing the contribution to VOUT to be disabled as illustrated in FIG. 4C. LOOP1 now has 100% control of the voltage regulation. The voltage difference between VFB1 and VFB2 should account for all extreme conditions through process/voltage/temperature/mismatch variations, the static errors of both loops finite gain amplifiers, their local mismatches and their global mismatches as well. In an embodiment, to cover all extreme conditions through process/voltage/temperature/mismatch variations, the voltage difference between VFB2 and VFB1 is 100 mV, which is approximately four times the thermal voltage (VT) of approximately 25.7 mV at 25° C.

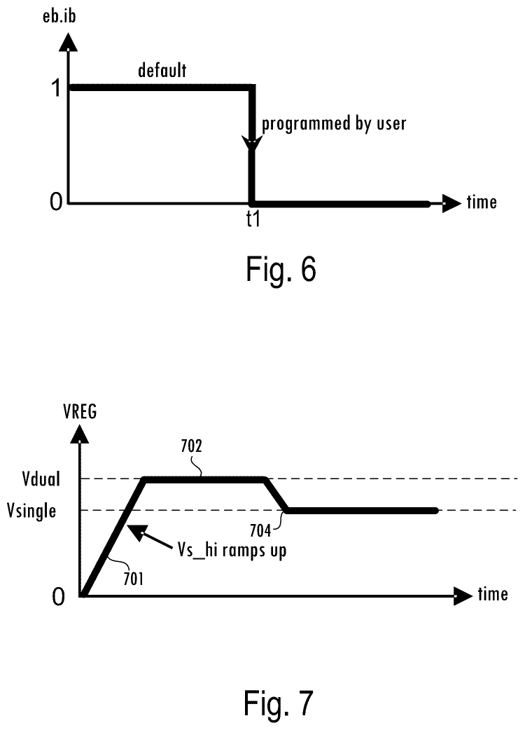

Once startup is completed using the default setting to prioritize LOOP1, in an embodiment the user programs the desired control loop settings. In an embodiment the user programs which loop is operating and therefore which pass transistor is being used by writing to a register (or other storage location) containing the EB and IB enable bits. For example, writing a logical 1 to the external ballast (EB) enable bit location supplying the EB enable signal 342 (see FIGS. 3 and 5) enables LOOP1 and writing a logical 0 disables LOOP1. Referring to FIGS. 3 and 5, disabling LOOP1 is accomplished by turning off the error amplifier, e.g., by turning off the current source 509. A logical 1 written to the internal ballast (IB) enable bit location supplying the IB enable signal 344 enables LOOP2 and a logical 0 disables LOOP2. Referring to FIGS. 3 and 5, disabling LOOP2 is accomplished by turning off the error amplifier, e.g., by turning off the current source 549. FIG. 6 illustrates the default startup period in which both EB and IB are a logical one. After the startup period ends, the user programs the desired functionality by writing one or both of the enable bits to a logical zero. For example, the user may write EB=1 and IB=0 to enable only the external ballast, EB=0 and IB=1 to enable the internal ballast, or EB=0 and IB=0 to shut off both the internal ballast and the external ballast. After startup, in a typical application the external ballast (LOOP1) is utilized and thus the user programs IB=0 and EB=1. Of course, in an application in which less load current is required and no external ballast is present, the internal ballast can be used and thus LOOP1 is disabled and LOOP2 enabled. Note that in embodiments there is only a need to disable one of the ballasts if the control bits can be separately accessed as both are enabled coming out of startup.

FIG. 7 illustrates another aspect of the dual tap approach to startup regulation described herein. As the power supply VS_hi, which supplies power to the pass devices (see FIG. 5), ramps up, at the end of startup the regulated output voltage VOUT 701 is at 702 (Vdual) when the dual regulation loops LOOP1 and LOOP2 are being used concurrently in conjunction with the two-tap voltage divider. However, assume that after startup completes, the user programs EB=1 and IB=0, then the output voltage VOUT drops to Vsingle 704, where Vsingle corresponds to a single regulation loop being used (LOOP1) in conjunction with the feedback voltage for LOOP1 from the voltage divider coming from node 536 (between R3 and R2 in FIG. 5). Still referring the FIG. 5, the EB enable signal for the external ballast and the IB enable signal for the internal ballast are also utilized to control the switches 538 and 540, which affects the voltage values of Vdual and Vsingle. That is, with IB=0, VFB1 comes from node 536 with switch 538 open and 540 closed.

Referring again to FIG. 5, ΔV (the voltage difference between VFB1 and VFB2) is given by ΔV=VREF×R2/R1. Voltage divider values useful in determining VOUT (the voltage supplied to the load at node 541) include,

$$K 1 = [ 1 + R 3 / ( R 1 + R 2 ) ] , and K 2 = [ 1 + ( R 3 + R 2 ) / R 1 ] .$$

K2 can be seen to be larger than K1. At the end of startup with both loops enabled, VOUT=(EB.IB×ΔV+VREF)×K1, where EB.IB represents the AND of the two control bits. The voltage VOUT depends on whether the two-tap voltage divider is used. Where the two tap voltage divider is used with both LOOP1 and LOOP2 enabled,
Vdual=(VREF+ΔV)× K1=VREF× K2. However, as shown in FIG. 7, Vsingle has a lower voltage than Vdual, Vsingle=VREF×K1. Vsingle and Vdual differ due to a single control loop being active and because of the switch settings of switches 538 and 540 based on the values of IB and EB. With both control bits enabled switch 538 is closed and switch 540 is open resulting in VFB1 being sourced from the node between R1 and R2. With one of the control bits disabled, switch 538 is open and switch 540 is closed resulting in VFB1 being sourced from the node between R3 and R2. That makes VFB1 have a higher voltage in the Vsingle mode, which reduces the output voltage VOUT as compared to both control loops running concurrently. In an embodiment, the output voltage at Vsingle is ˜ 6V and Vdual is ˜ 6.6V. If the user prefers the lower voltage for VOUT, the user has the option to program the desired regulation loops. Of course, the difference in voltage between Vdual and Vsingle depends on the particular implementation for the various circuit components including the error amplifiers, the value of VREF, and the values of the resistors in the voltage divider.

A voltage regulator utilizes an external pass transistor coupled between a supply voltage node and a regulated node. The voltage regulator includes an internal pass transistor that is coupled between the supply voltage node and the regulated node. A two-tap voltage divider between the regulated node and a ground node provides two feedback voltages. A first control loop that controls the external pass transistor receives the first feedback voltage and a second control loop that controls the internal pass transistor receives the second feedback voltage. At startup the control loops run concurrently but the first control loop is prioritized to reduce load current provided by the internal pass transistor at the end of startup. The voltage difference between the first and second feedback voltages ensures prioritization of the first control loop and the external pass transistor supplies most or all of the load current.

Thus, providing concurrently running control loops at startup for a voltage regulator helps ensure safe startup even without knowledge of the presence of an external pass transistor. The control loop for the external pass device is given priority to ensure that excessive current does not flow through the internal pass transistor to avoid potential thermal damage. In this specification, example embodiments have been presented in terms of a selected set of details. However, a person of ordinary skill in the art would understand that many other example embodiments may be practiced which include a different selected set of these details. It is intended that the following claims cover all possible example embodiments. Although the invention is described herein with reference to specific embodiments, various modifications and changes can be made without departing from the scope of the present invention as set forth in the claims below. Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements.

1. A voltage regulator comprising:
a first control loop to generate a first control signal for a first pass transistor, the first control signal coupled to an output terminal of an integrated circuit;
a second pass transistor internal to the integrated circuit and coupled between a supply voltage node and a regulated voltage node;
a second control loop to generate a second control signal for the second pass transistor; and
a voltage divider circuit coupled between the regulated voltage node and a ground node to provide a first feedback voltage from a first tap of the voltage divider circuit to the first control loop and to provide a second feedback voltage from a second tap of the voltage divider circuit to the second control loop.

2. The voltage regulator as recited in claim 1, further comprising the first pass transistor external to the integrated circuit, the first pass transistor being coupled to the first control signal through the output terminal of the integrated circuit, the first pass transistor coupled between the supply voltage node and the regulated voltage node.

3. The voltage regulator as recited in claim 1, wherein the first control loop has a higher priority than the second control loop to thereby reduce an amount of current supplied by the second pass transistor.

4. The voltage regulator as recited in claim 1, wherein the first control loop comprises a first error amplifier having a first input coupled to the first feedback voltage and a second input coupled to a reference voltage, the first error amplifier supplying the first control signal.

5. The voltage regulator as recited in claim 4, wherein the second control loop comprises a second error amplifier having a first input coupled to the second feedback voltage and having a second input coupled to the reference voltage, the second error amplifier generating the second control signal that is coupled to a control terminal of the second pass transistor.

6. The voltage regulator as recited in claim 5, wherein during a startup sequence, by default the first control loop and the second control loop run concurrently and the first control loop is prioritized to ensure the first pass transistor provides more current than the second pass transistor at an end of the startup sequence and after the startup sequence completes the first control loop can be disabled and the second control loop can be disabled.

7. The voltage regulator as recited in claim 5, further comprising a first switch and a second switch to cause the first error amplifier to receive the first feedback voltage responsive to assertion of both an external ballast enable signal and an internal ballast enable signal and to receive the second feedback voltage responsive to the internal ballast enable signal being deasserted.

8. The voltage regulator as recited in claim 5,
wherein the first error amplifier is responsive to a first value of an external ballast enable signal to turn on and to a second value of the external ballast enable signal to turn off to thereby disable the first pass transistor; and
wherein the second error amplifier is responsive to a first value of an internal ballast enable signal to turn on and to a second value of the internal ballast enable signal to turn off and thereby disable the second pass transistor.

9. The voltage regulator as recited in claim 5, further comprising a plurality of switches configured to select the first feedback voltage for the first control loop during startup and to select the second feedback voltage for the first control loop responsive to the second control loop being disabled after startup.

10. A method for generating a regulated voltage comprising:
controlling a first pass transistor that is external to an integrated circuit using a first control loop;
controlling a second pass transistor that is internal to the integrated circuit using a second control loop that runs concurrently with the first control loop;
supplying a first feedback voltage from a first tap of a voltage divider circuit to the first control loop; and
supplying a second feedback voltage from a second tap of the voltage divider circuit to the second control loop.

11. The method as recited in claim 10, further comprising prioritizing use of the first pass transistor based on a voltage difference between the first feedback voltage and the second feedback voltage.

12. The method as recited in claim 10, further comprising:
supplying the first feedback voltage to a first input of a first error amplifier in the first control loop;
supplying a reference voltage to a second input of the first error amplifier; and
supplying an error output signal of the first error amplifier to a control terminal of the first pass transistor to control the first pass transistor.

13. The method as recited in claim 12, further comprising causing the first error amplifier to receive the second feedback voltage after a startup sequence.

14. The method as recited in claim 12, further comprising turning on the first error amplifier responsive to a first value of an external ballast enable signal and turning off the first error amplifier responsive to a second value of the external ballast enable signal to thereby disable the first pass transistor.

15. The method as recited in claim 10, further comprising:
supplying the second feedback voltage to a first input of a second error amplifier in the second control loop;
supplying a reference voltage to a second input of the second error amplifier; and
supplying an error output signal of the second error amplifier to a control terminal of the second pass transistor to control the second pass transistor.

16. The method as recited in claim 15, further comprising prioritizing the first control loop by default during a startup sequence.

17. The method as recited in claim 16 further comprising disabling the first control loop or the second control loop after the startup sequence completes.

18. The method as recited in claim 15, further comprising turning on the second error amplifier responsive to a first value of an internal ballast enable signal and turning off the second error amplifier responsive to a second value of the internal ballast enable signal to thereby disable the second pass transistor.

19. A voltage regulator comprising:
an internal pass transistor internal to an integrated circuit and coupled between a supply voltage node and a regulated voltage node;
a voltage divider circuit coupled between the regulated voltage node and a ground node to provide a first feedback voltage from a first tap of the voltage divider circuit and to provide a second feedback voltage from a second tap of the voltage divider circuit;
a first control loop to supply a first control signal to an output terminal of the integrated circuit, the first control signal for controlling an external pass transistor, the first control loop including a first error amplifier coupled to receive the first feedback voltage and to receive a reference voltage and to supply a first error amplifier output signal as the first control signal;
a second control loop to supply a second control signal to a control terminal of the internal pass transistor, the second control loop including a second error amplifier coupled to receive the second feedback voltage and to receive the reference voltage and to supply a second error amplifier output signal as the second control signal; and
wherein a voltage difference between the first feedback voltage and the second feedback voltage prioritizes the first control loop.

20. The voltage regulator as recited in claim 19, further comprising the external pass transistor external to the integrated circuit, the external pass transistor coupled to the first control signal through the output terminal of the integrated circuit, the external pass transistor coupled between the supply voltage node and the regulated voltage node.
